(19) United States
(12) Patent Application Publication
(10) Pub. No.: US 2003/0096633 A1
(43) Pub. Date: May 22, 2003

(54) HUMAN INTERFACE DETECTION AND SWITCHING

(76) Inventor: STEVEN JEFFREY GOLDBERG, FORT WORTH, TX (US)

Correspondence Address: MOTOROLA INC, 600 NORTH US HIGHWAY 45, LIBERTYVILLE, IL, 60048-5343, US

(21) Appl. No.: 09/570,501

(22) Filed: May 13, 2000

(51) Int. Cl. H04M 1/00

(52) U.S. Cl. 455/556; 455/41; 455/566

(57) ABSTRACT

A method and apparatus for enabling a desired human/machine interface including providing the desired human/machine interface by an initiating device, if it is capable. Otherwise, the desired human/machine interface is switched to an interface device accessible to the initiating device, if the interface device is capable of providing the desired human/machine interface.

### FIELD OF THE INVENTION

The invention relates generally to human interface detection and switching. More particularly, the invention relates to a method and apparatus for switching a human interface to a device more capable of providing it.

### BACKGROUND OF THE INVENTION

The proliferation of pagers, cellular telephones, desktop computers, laptop computers, personal digital assistants (PDAs) and other similar devices and the interconnection of those devices through such media as wired networks, wireless networks, satellite networks and the Internet allows great flexibility in the ways people acquire information and communicate with each other. For example, a person may receive a page with an alphanumeric message requesting an item of information. The person may use his laptop, his pager, or his PDA to browse the Internet to find the requested information. The person may then compose an email on his laptop or PDA and transmit the information to the person requesting it. The person has the flexibility to chose from among a number of combinations of communication devices.

Such communications devices may be characterized, in part, by the specialized human interface capabilities they provide. For example, a pager may include a small display screen for displaying received messages. It may also include controls, such as switches or buttons, to allow a person operating it to connect to and navigate through the Internet. Desktop computers and laptop computers, which are typically not as portable as pagers, provide sophisticated human interfaces through display screens, comprehensive keyboards, mice and other such devices. Printers allow a presentation of text and graphics that may be superior to that shown on a computer's display screen. Thus, the human interface capabilities of a particular communications device may be better suited for some tasks than the human interface capabilities of another communications device. What is needed is a means of enhancing or expanding human interference capabilities available to a user of a device.

### BRIEF DESCRIPTION OF THE DRAWINGS

FIG. 1 is a representation of a pager according to the present invention.

FIG. 2 is a representation of tables showing ways of communicating interface capabilities of devices.

FIG. 3 is a block diagram of a communications device according to the present invention.

FIG. 4 is a block diagram of a Bluetooth system element.

FIGS. 5-6 and 8 are flow charts of processing according to the present invention.

FIG. 7 is a representation of a pager displaying a message according to the present invention.

FIG. 9 illustrates local area discovery according to the present invention.

FIG. 10 illustrates network discovery according to the present invention.

FIG. 11 illustrates augmentation according to the present invention.

### DETAILED DESCRIPTION OF THE INVENTION

The invention provides the ability to expand the human interface capabilities available to a user communicating through an initiating device by sensing the human interface capabilities of devices accessible to the initiating device, directly or through a network. If the class or features of the initiating device do not match what is required for a selected service the initiating device can switch the selected service to one of the accessible devices that does provide a match. The switch may be partial, in which case the initiating device remains part of the communications path, or it may be complete, in which case the initiating device is, at least temporarily, removed from the communications path.

An example of an initiating device, illustrated in FIG. 1, is a pager 102. The initiating device can be any communications device. The pager 102 includes a display screen 104 for displaying received messages and various controls 106 for controlling and navigating through the information displayed on the display screen 104. The pager 102 shows a list of services on its screen 104: “Email,” “Instant Messaging,” “Phone,” “Web browsing (basic),” and “Web browsing (full).” It will be understood that the list of selectable services is not limited to those shown in FIG. 1.

A user may select one or more of the services by moving a “cursor,” indicated by highlighting on the screen, using a cursor control 108, and then selecting the highlighted service with an enter control 110. In FIG. 1, the “Instant Messaging” selection is highlighted. The user can select that service by pressing the enter control 110. Alternatively, the user may select one of a number of possible modes of operation for an initiating device. Each mode of operation will have associated with it one or more services, such as email or instant messaging, that must be supported in that mode.

Each service has associated with it one or more “classes,” of support devices or an explicit listing of features. For example, as illustrated in FIG. 2, table 202 is a description of “Class X,” which identifies a class of devices, including an input (a keyboard), an output (a display) and a network connection, which can be specified simply by designating “Class X.” Table 204 is an explicit listing of features for the input, output and network interfaces.

The initiating device may or may not be suitable for the selected service. For example, in FIG. 1, the illustrated pager may be in the proper class or provide the proper features for the Email, Instant Messaging and Web browsing (basic) services but might be completely unsuitable for other services, such as the Phone and Web browsing (full) services.

Further, the initiating device may provide a limited version of the service. For example, the pager illustrated in FIG. 1 could receive instant messages but might not be capable or efficient for preparing instant messages.

In the latter case, where the initiating device is only suited in a limited sense for the requested service, the initiating device offers the user the choice of whether to proceed with the existing support that the initiating device provides or to search for an accessible device that would match the required class or features.

To accomplish this, the initiating device includes a sensor/transmitter 302, as illustrated in FIG. 3. The sensor/transmitter 302 is coupled to a processor 304, which receives inputs from a human/machine input device 306 and provides outputs to a human/machine output device 308. FIG. 3 illustrates a generalized and simplified initiating device and does not illustrate some components generally found in such devices. For example, non-human interfaces are not shown. Further, some initiating devices will deviate from the generalized version shown. For example, a display screen may not include the human/machine input device 306.

The sensor/transmitter 302 allows the initiating device to communicate with other devices. The communication may be optical, using for example infrared communications, electromagnetic, using for example radio communications, or through a direct wired connection. In the case of infrared communications, the communications protocol may be established by the current Infrared Data Association (IrDA) specifications and standards available at www.irda.org.

In the preferred embodiment, the communications are provided by radio link in accordance with the Specification of the Bluetooth System, available at www.bluetooth.com, and incorporated by reference. According to the Core Specification of the Bluetooth System, version 1.0B (Dec. 1, 1999), Baseband Section, General Description: “Bluetooth is a short-range radio link intended to replace the cable(s) connecting portable and/or fixed electronic devices. Key features are robustness, low complexity, low power, and low cost.

“Bluetooth operates in the unlicensed ISM [Instrumentation, Scientific Medical] band at 2.4 GHz. A frequency hop transceiver is applied to combat interference and fading. A shaped, binary FM modulation is applied to minimize transceiver complexity. The symbol rate is 1 Ms/s. A slotted channel is applied with a nominal slot length of 625 μs. For full duplex transmission, a Time-Division Duplex (TDD) scheme is used. On the channel, information is exchanged through packets. Each packet is transmitted on a different hop frequency. A packet nominally covers a single slot, but can be extended to cover up to five slots.

“The Bluetooth protocol uses a combination of circuit and packet switching. Slots can be reserved for synchronous packets. Bluetooth can support an asynchronous data channel, up to three simultaneous synchronous voice channels, or a channel which simultaneously supports asynchronous data and synchronous voice. Each voice channel supports a 64 kb/s synchronous (voice) channel in each direction. The asynchronous channel can support maximal 723.2 kb/s asymmetric (and still up to 57.6 kb/s in the return direction), or 433.9 kb/s symmetric.”

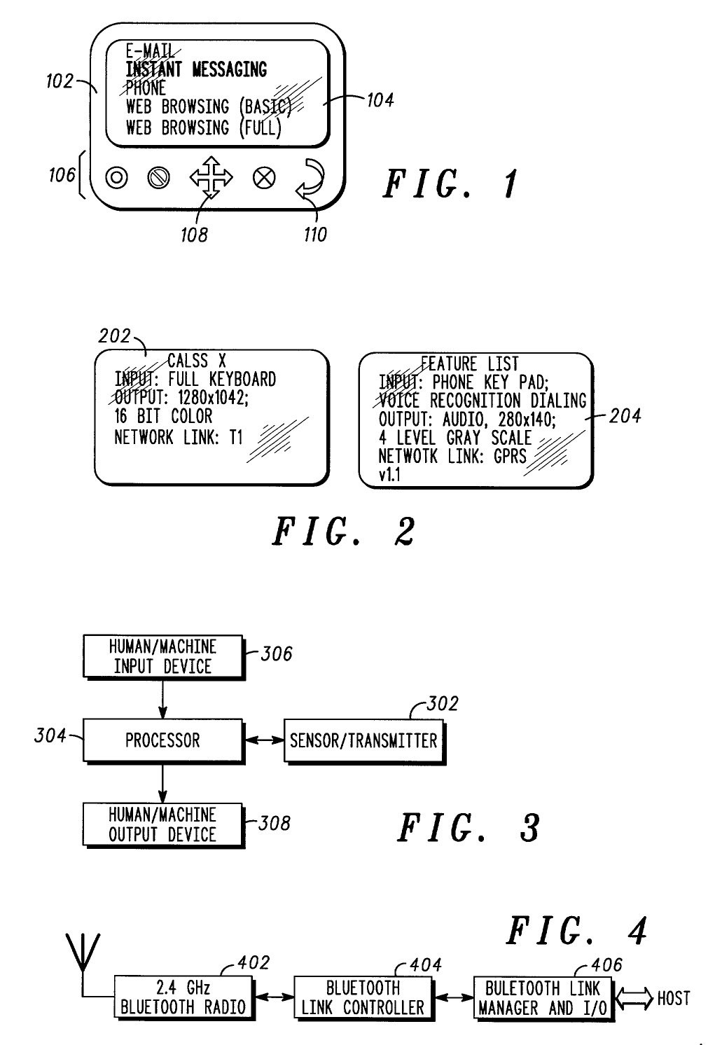

Each Bluetooth system element includes a radio unit 402, a link control unit 404, and a support unit 406 for link management and host terminal interface functions, as shown in FIG. 4.

As further stated in the Bluetooth Specification: “The Bluetooth system provides a point-to-point connection (only two Bluetooth units involved), or a point-to-multipoint connection . . . . In the point-to-multipoint connection, the channel is shared among several Bluetooth units. Two or more units sharing the same channel form a ‘piconet.’ One Bluetooth unit acts as the master of the piconet, whereas the other unit(s) acts as slave(s). Up to seven slaves can be active in the piconet. In addition, many more slaves can remain locked to the master in a so-called parked state. These parked slaves cannot be active on the channel, but remain synchronized to the master. Both for active and parked slaves, the channel access is controlled by the master.

“Multiple piconets with overlapping coverage areas form a ‘scatternet.’ Each piconet can only have a single master. However, slaves can participate in different piconets on a time-division multiplex basis. In addition, a master in one piconet can be a slave in another piconet. The piconets shall not be time- or frequency-synchronized. Each piconet has its own hopping channel.”

In one embodiment, the initiating device is the master of a Bluetooth piconet. For example, the initiating device may be a pager as illustrated in FIG. 1. It may be close enough to several other devices equipped with Bluetooth transceivers, such as a keyboard, a display device and a computer with a network interface, to establish communications with those devices. Those devices form the slaves in the piconet.

In other embodiments, the initiating device is a slave. This might occur when one of the other devices equipped with a Bluetooth transceiver has a more robust power source than the initiating device. For example, if the initiating device is a pager, it may be a slave in a piconet in which a desktop computer is the master.

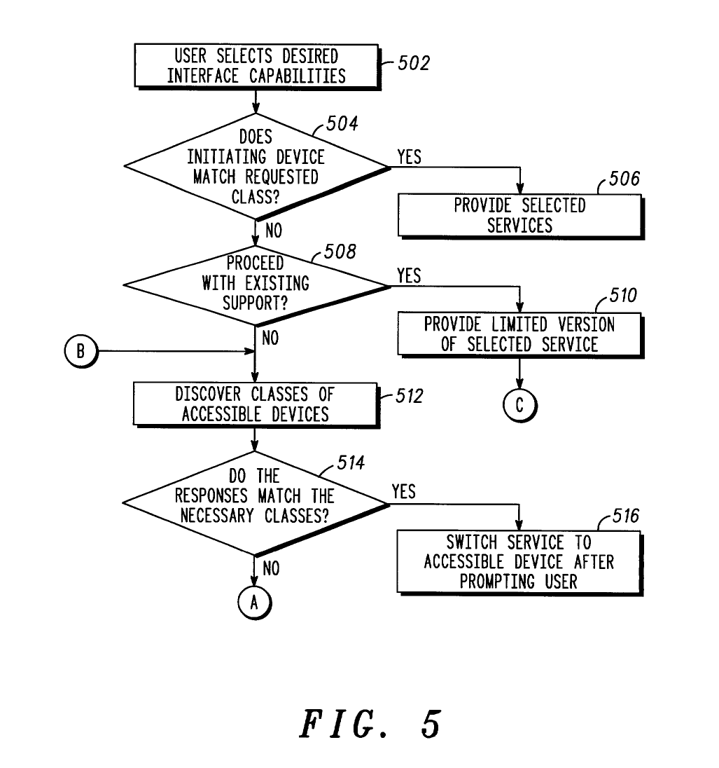

When the user selects the desired interface capabilities (block 502), as shown in FIG. 5, the initiating device's processor identifies a class of devices or an explicit list of features required to support the requested interface capabilities. The processor then determines whether the initiating device matches that class or list of features (block 504). If it does, the initiating device provides the selected capabilities (block 506). This would happen, for example, if the initiating device is a pager and the selected service is email.

If the initiating device is not capable of providing the selected class or list of features, for example if the initiating device is a pager and the phone service is selected, the initiating device displays a message asking the user whether to proceed with the existing support (block 508). If the user responds “yes,” the initiating device proceeds to provide a limited version of the requested service (block 510).

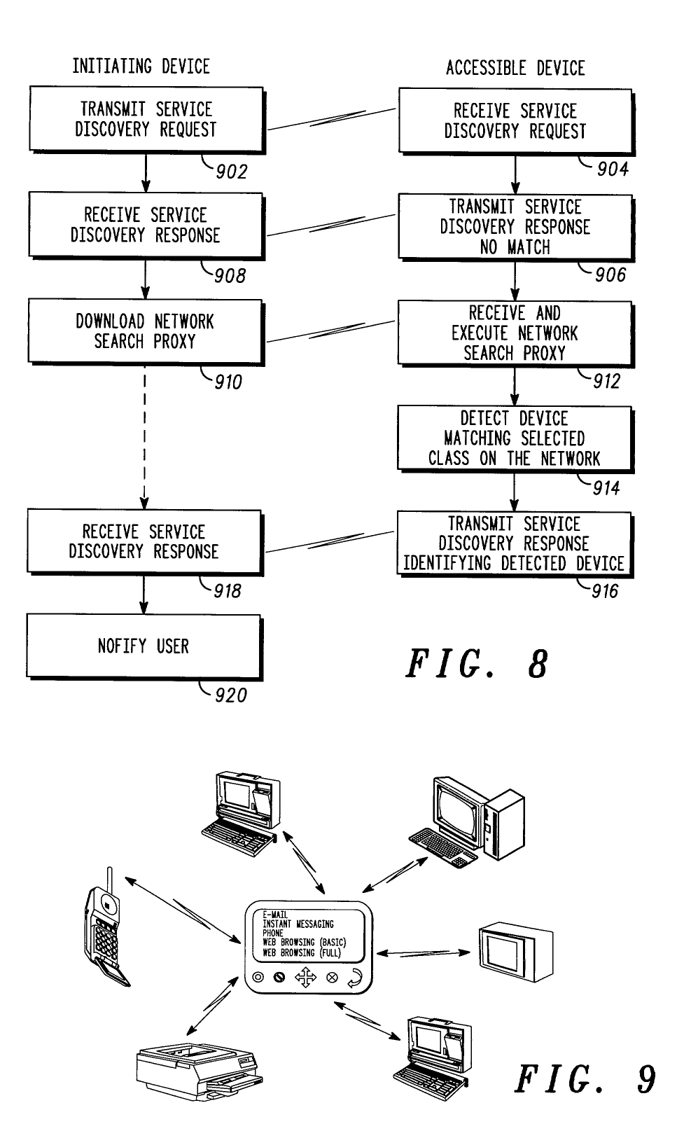

If the user indicates a desire to search for a device fitting into the requested class or providing the requested features, the initiating device discovers the capabilities of devices (also called “servers” or “slaves”) accessible through its sensor/transmitter (block 512). The mechanics of the discovery process are discussed below. The initiating device then determines if the discovered capabilities of the accessible devices match the selected class or list of features (block 514). If they do, for example if a keyboard service is requested and a keyboard is discovered, the initiating device requests permission from the user to switch the service, for example by displaying a message on the display screen, as shown in FIG. 7. Upon receiving permission, the initiating device switches the requested service to the accessible device or devices capable of providing the service (block 516). “Switching” is discussed below.

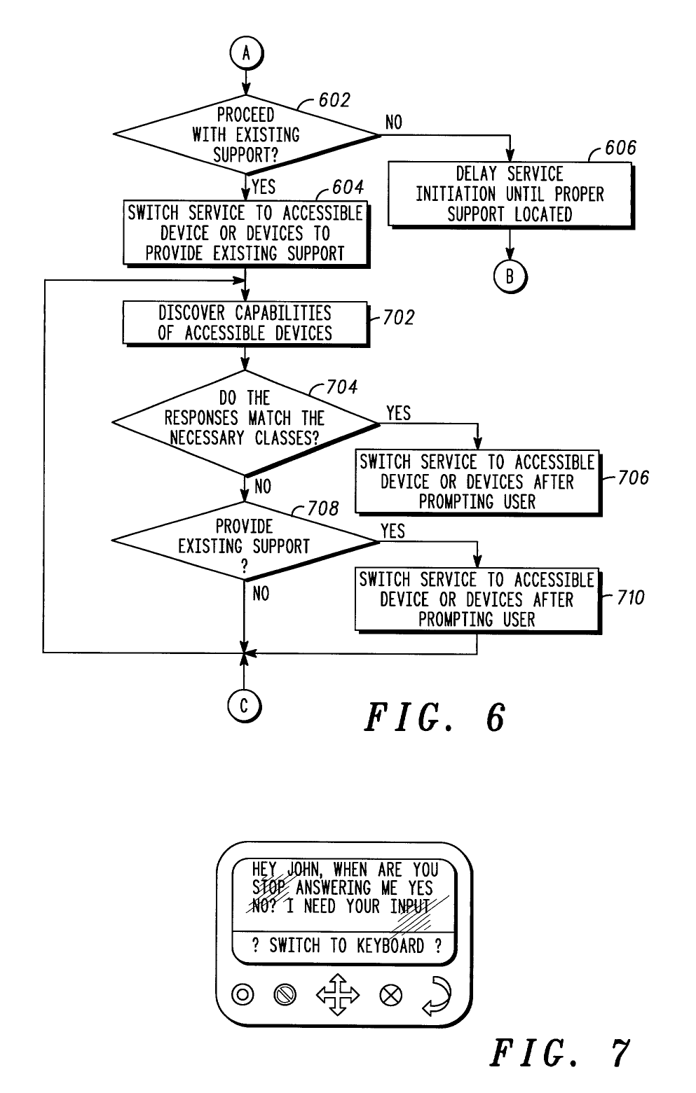

If, however, the discovered capabilities of the accessible devices do not match the selected class or list of features, the user is asked, for example through a message on the display screen, whether to start the service with existing support provided by the accessible device or devices (block 602), as illustrated in FIG. 6. If the user decides to proceed with existing support provided by the accessible device or devices, a limited version of the selected services or features is provided by the accessible device or devices (block 604).

The user may decide not to proceed with the existing support. In that case, the service is delayed until proper support is located (block 606). With the selected service pending, the initiating device again discovers the capabilities of the accessible devices (block 512 on FIG. 5). Consequently, if any new devices become accessible, the initiating device will become aware of their capabilities and determine whether the service should be switched to them as described above.

In the cases where the limited versions of the requested service are provided by the initiating device or by one or more accessible devices, the initiating device continues to search for accessible devices in the requested class or which are capable of providing the requested features. Consequently, if any devices become accessible, for example because the user holding the initiating device moves into a different area, the initiating device will discover such accessible devices, determine if they match the requested class or features, and, if they do, switch the service to them.

In this mode, the initiating device continues to discover the capabilities of accessible devices (block 702), as shown in FIG. 6. If the discovered services provided by one or more of the accessible devices match the selected class or features (block 704), the initiating device switches the service to such accessible device or devices after asking the user for permission (block 706). Otherwise, if one or more of the accessible devices partially matches the selected classes and features (block 708), the initiating device switches the service to the new device or devices after asking the user for permission (block 710). If a device matching the class or features for the requested service has still not been found, the initiating device continues its search (block 702).

The initiating device discovers the capabilities of accessible devices by broadcasting to the accessible devices a message asking them to report their capabilities with respect to the selected class or features. The message may include a class designation, as discussed above with respect to FIG. 2. Alternatively, the message may include a list of desired features transmitted as shown in FIG. 2 or in a form such as XML, the eXtensible Markup Language, which allows great flexibility in the way information is transmitted.

Each of the accessible devices responds with a message describing the degree to which the services or features it supplies match the selected services or features. Alternatively, the initiating device may individually address each of the accessible devices and receive responses from each one in turn. In still another alternative, the accessible devices periodically transmit messages advertising their capabilities and the initiating device receives the messages and processes them.

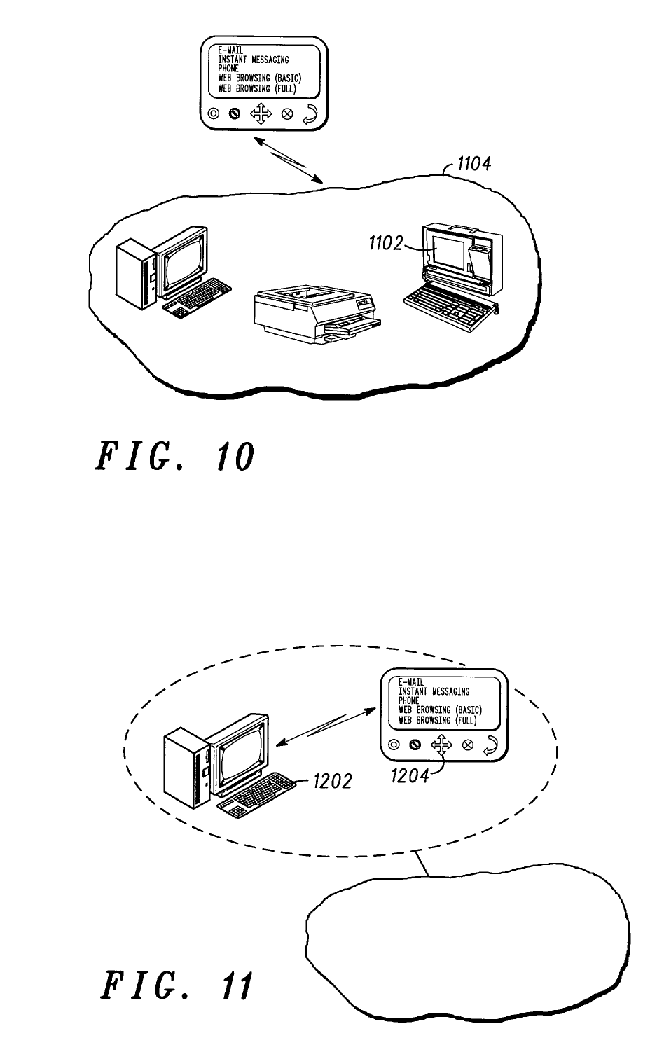

In the preferred embodiment, using a Bluetooth-based system, the initiating device transmits a service discovery request (block 902), as shown in FIG. 8. The service discovery request is transmitted to all Bluetooth equipped devices, as shown in FIG. 9. This is known as “local area discovery.” The service discovery request includes a designator for the class of device being requested or a list of specific features being sought. An accessible device receives the service discovery request (block 904), compares the selected class or features against its own class and list of features and provides a response to the initiating device (block 906). In FIG. 8, the accessible device responds that it does not match the selected class or features. Another possible response is that the accessible device does match the selected class or features.

The initiating device receives service discovery responses from all of the accessible devices (block 908). If all of the responses are negative, the initiating device may initiate a wider search for devices matching the selected class or features. For example, the initiating device may expand the search to devices 1102 connected to the accessible devices by network 1104, as illustrated in FIG. 10. This is known as “network discovery.” In network discovery, the initiating device downloads an agent or proxy to one or more of the accessible devices to perform the network search (block 910). The accessible device receives the network search proxy and executes it (block 912), causing service discovery messages to be transmitted over the network. The network search proxy transmits other proxies and agents across the network as necessary to accomplish the search. Alternatively, the necessary proxies and agents already exist as needed across the network before the search begins.

The network search proxy may detect a device on the network that matches the selected class or list of services (block 914). It includes that information in a service discovery response that it transmits to the initiating device (block 916). The initiating device receives the service discovery response (block 918) and notifies the user of the availability of the device matching the selected class of service and provides instructions for using the device, including, for example, the location of the device (block 920).

The accessible device may help the user make the switch. For example, if the accessible device is a keyboard, it may include a flashing light indicating that it is the device to which the initiating device is proposing switching a service. The user may then sit down in front of the keyboard, select the switchover, and begin typing inputs, which are wirelessly passed to the initiating device. When the accessible device is found via a network search, the accessible device and the initiating device may lead the user to the accessible device.

The service can be switched to one of the accessible devices entirely or as an augmentation of the initiating device. In the former circumstance, the initiating device ceases to be a part of the communications process. For example, if a pager receives a request for a phone service, the pager can switch the service request by forwarding the telephone call to a telephone discovered through the discovery process.

In the augmentation mode, illustrated in FIG. 11, the initiating device remains a part of the communications path. Even though the service is switched to an accessible device 1202, communications related to that service are routed through the initiating device 1204. For example, if the initiating device 1204 is a pager and a keyboard service was switched to a keyboard in the augmentation mode, typing on the keyboard would cause characters to appear on the pager display.

Augmentation may come as a group of devices, such as a desktop computer, which includes a processor, a keyboard, a display, a mouse, etc. Augmentation could also occur as a collection of devices. In an extreme case, the initiating device serves only as a coordinating node. For example, in an “e-commerce” situation, the identification of the user, payment means, and connectivity criteria may come from the initiating device. The display from a television set, inputs made via a keyboard, and a network connection may function from a nearby “pod.” Thus, a workable “network” has been cobbled together for the user. The network will become individual components when the connection is no longer needed.

In the augmentation mode, the accessible devices could be “dumb” and display only that which is sent to them by the initiating device. Alternatively, the accessible devices could run a program, which may be downloaded from a network or from the initiating device, using their greater processing power. The accessible device may pass information back to the initiating device for display.

Further, the initiating device's inputs could remain active, since in some cases its controls may be superior to those provided by the accessible devices (e.g. a toggle paddle).

If the initiating device is operating in the augmentation mode and the user moves the initiating device so that it loses its connection to the accessible device, the user is prompted on the display and full control of the switched service returns to the initiating device.

It is understood that the initiating device and the accessible devices each include some form of processor, preferably executing software (firmware) programs, to effectuate in a cooperative fashion the functions or processes, or etc. disclosed above. The specific programs are not discussed but would be well within the wherewithall that one of ordinary skill in the art given the teachings of the present invention.

The foregoing describes preferred embodiments of the invention and is given by way of example only. The invention is not limited to any of the specific features described herein, but includes all variations thereof within the scope of the appended claims.

What is claimed is:

1. A communications device comprising
an input for selecting a desired interface capability;
acquired interface capabilities for one or more accessible devices;
an output for indicating which, if any, accessible device is capable of providing the desired interface capability.

2. The communications device of claim 1 further comprising
a sensor for sensing the acquired interface capabilities.

3. The communications device of claim 1 further comprising
a transmitter for sending a request for interface capabilities to the one or more accessible devices to respond with their interface capabilities.

4. The communications device of claim 1 further comprising
a transceiver for acquiring the acquired interface capabilities for the one or more accessible devices.

5. The communications device of claim 4 wherein
the transceiver is a Bluetooth transceiver.

6. A method of providing desired interface capabilities comprising
selecting at least one desired interface capability;
sensing the interface capabilities of one or more accessible devices;
indicating which, if any, of the one or more accessible devices are capable of providing the desired interface capability.

7. The method of claim 6 further comprising
transmitting a request to the one or more accessible devices requesting their interface capabilities.

8. The method of claim 6 further comprising
switching the desired interface capability to one or more of the one or more accessible devices capable of providing the desired interface capability.

9. The method of claim 8 wherein switching comprises
using the interface capabilities of the one or more accessible devices to augment the initiating device.

10. The method of claim 8 wherein switching comprises
using the interface capabilities of the one or more accessible devices to replace the initiating device for their desired interface capabilities.

11. The method of claim 6 wherein selecting comprises
choosing a mode of operation which invokes the desired interface capability.

12. The method of claim 6 wherein indicating comprises
displaying a message on a display screen.

13. A method, performed by an initiating device, for enabling a desired human/machine interface comprising
providing the desired human/machine interface by the initiating device, if it is capable;
switching the desired human/machine interface to a first interface device accessible to the initiating device, if the first interface device is capable of providing the desired human/machine interface and the initiating device is not capable.

14. The method of claim 13 further comprising
suspending the desired human/machine interface if the initiating device is not capable and no interface device accessible to the initiating device is capable.

15. The method of claim 14 further comprising
reviving the desired human/machine interface if a second interface device that is capable becomes accessible to the initiating device.

16. The method of claim 13 further comprising
sensing the human/machine interface capabilities of the interface device accessible to the initiating device.

17. The method of claim 16 wherein sensing comprises
requesting from the interface device a report of its human/machine interface capabilities.

18. The method of claim 17 wherein sensing further comprises
receiving from the interface device the requested report.

19. The method of claim 13 wherein switching comprises
transferring the human/machine interface to the first interface device.

20. The method of claim 13 wherein switching comprises
coupling the first interface device to the initiating device.

21. The method of claim 13 further comprising
indicating to the operator the possibility of switching the desired human/machine interface to the first interface device.
